(19) United States
(12) Patent Application Publication
(10) Pub. No.: US 2016/0204886 A1
(43) Pub. Date: Jul. 14, 2016

(54) METHOD AND APPARATUS OF RADIO INTERFERENCE ESTIMATION BASED ON RECEIVED SIGNAL STRENGTH IN WIRELESS COMMUNICATION SYSTEM

(71) Applicant: ELECTRONICS AND TELECOMMUNICATIONS RESEARCH INSTITUTE, Daejeon (KR)

(72) Inventor: Heon Jin HONG, Daejeon (KR)

(21) Appl. No.: 14/592,216

(22) Filed: Jan. 8, 2015

(51) Int. Cl. H04B 17/345

(52) U.S. Cl. CPC H04B 17/345; H04W 52/243

(57) ABSTRACT

The present invention relates to a method for performing an interference management based on received interference signal strength, the interference management apparatus comprises a parameter setting unit configured to set up a permissible interference reference I_{A} of an allowable band and a percentage reference Q of an interference region, a communicating unit configured to receive information related to the received interference signal strength which is measured by at least a terminal from at least a terminal or a base station, and a comparing and determining unit configured to determine that interference excess is generated, in case that the received interference signal strength i_{A} of an allowable band exceeds the permissible interference reference I_{A}. According to the present invention, it is available to figure out an interference effect which a victim receiver undergoes within a permitted region accurately.

Priority to Korean patent application number 10-2014-0021559 filed on Feb. 24, 2014, the entire disclosure of which is incorporated by reference herein, is claimed.

### BACKGROUND OF THE INVENTION

1. Field of the Invention

The present invention relates to wireless communications and more particularly to a method and apparatus of radio interference estimation based on received signal strength in wireless communication systems.

2. Discussion of the Related Art

Currently, as the use of wireless communication services increases, so relatively does the number of wireless communication systems that are operating proximal to one another in frequency, space and time, thereby a problem of radio interference has been raised.

In conventional radio interference management systems, the radio interference has been managed based on the transmission power of a transmitter. FIG. 1 illustrates permissible standards according to an embodiment of conventional radio interference management measures. In the conventional systems, as shown in FIG. 1, the transmission power of a transmitter and permissible standards for respective frequency bands are compared by enacting permissible standards P_{A} and P_{B} for each frequency band. Since such a way in which a measuring equipment is directly connected to an output terminal of a transmitter, it is easy to determine whether to exceed the permissible level. Even if the signal is transmitted with the same output, the interference amount that neighboring band users are received can be changeable according to a variety of factors such as a height of a transmission radio station, characteristics of a transmission antenna, a density of a transmission radio station and so on. However, in the conventional management systems, there was a difficulty to accurately determine the degree of interference that actually influences on radio stations of the adjacent band as there was no consideration of the above factors but solely considering the output of a transmitter for each band.

### SUMMARY OF THE INVENTION

It is a principal object of the present invention is to provide a method and apparatus of radio interference estimation based on received signal strength in wireless communication systems.

It is another object of the present invention is to provide a method and apparatus of interference limitation based on received interference signal strength.

It is further object of the present invention is to detect an interference region and interference time based on received interference signal strength.

It is still further object of the present invention is to detect a percentage of an interference region and interference time based on received interference signal strength measured from multiple mobile terminals.

According to an aspect of the present invention, an interference management apparatus which performs interference management based on received interference signal strength is provided. The interference management apparatus includes a parameter setting unit configured to set up a permissible interference reference I_{A} of an allowable band and a percentage reference Q of an interference region, a communicating unit configured to receive information related to the received interference signal strength which is measured by at least a terminal from at least a terminal or a base station, and a comparing and determining unit configured to determine that interference excess is generated, in case that the received interference signal strength i_{A} of an allowable band exceeds the permissible interference reference I_{A}.

According to an aspect of the present invention, a method for managing interference performed based on received interference signal strength is provided. The method for managing interference includes setting up a permissible interference reference I_{A} of an allowable band and a percentage reference Q of an interference region, receiving information related to the received interference signal strength which is measured by at least a terminal from at least a terminal or a base station, and determining that interference excess is generated, in case that the received interference signal strength i_{A} of an allowable band for respective terminals exceeds the permissible interference reference I_{A}.

According to yet another aspect of the present invention, an interference management systems based on received interference signal strength is provided. The interference management system includes at least a terminal configured to measure at least one of the received interference signal strength i_{A} of an allowable band and the received interference signal strength i_{B} of a non-allowable band, at least a base station configured to receive at least one of the i_{A} and i_{B} from at least one of the terminals; and a interference management apparatus configured to receive at least one of the i_{A} and i_{B} from at least one of the base stations, and to compare the i_{A} or is with the permissible interference reference I_{A} of the allowable band or the permissible interference reference I_{B} of the non-allowable band, and to determine whether interference excess is generated for each terminal.

### BRIEF DESCRIPTION OF THE DRAWINGS

FIG. 1 illustrates permissible standards according to an embodiment of the existing radio interference management measures.

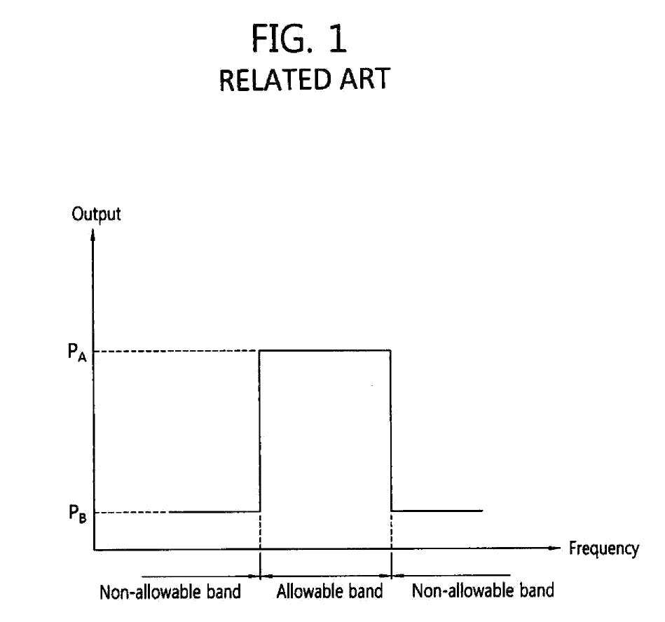

FIG. 2 illustrates permissible standards according to an embodiment of radio interference management measures based on the signal strength measured by the receiving unit which the present invention is applied to.

FIG. 3 illustrates an embodiment of interference management based on received interference signal strength which the present invention is applied to.

FIG. 4 illustrates an interference information measuring method according to an embodiment of the present invention.

FIG. 5 illustrates an embodiment of the interference percentage calculating method based on the interference management apparatus according to the present invention.

FIG. 6 is a block diagram schematically illustrating the interference management apparatus according to the present invention.

### DETAILED DESCRIPTION OF THE INVENTION

The present invention suggests a radio interference management system based on received signal strength, not a radio interference management system based on the existing transmission power. The present invention is to detect an interference region and interference time that exceed permissible interference standards within a permitted region where is, operated in wireless communication systems based on the information of received signal strength which is measured from a terminal, a receiving unit, and suggests a method of calculating percentages for this.

The preferred embodiment of the present invention now will be described in detail by reference to the accompanying exemplary drawings in this specification. In attaching reference numerals to elements in each drawing, it should be understood that the same reference numeral is used for the same element even if the element is shown in different drawings. In addition, in case that the detailed description for the related known elements and functions is determined to obscure the inventive concept in this specification, the redundant description for the same element will be omitted.

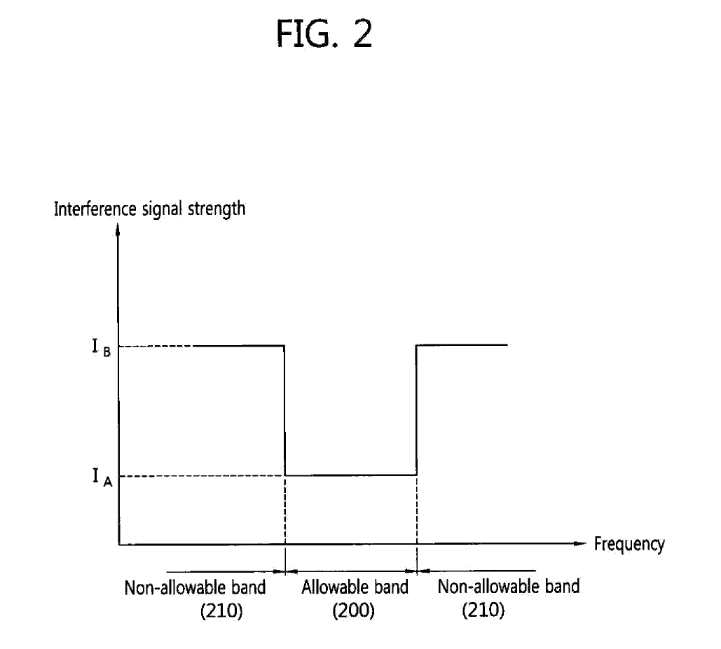

FIG. 2 illustrates permissible standards according to an embodiment of radio interference management measures based on the signal strength measured by the receiving unit which the present invention is applied to.

Referring to FIG. 2, a permissible interference reference for each of the bands may be determined by classifying permissible interference levels into an allowable band 200 and non-allowable band when a licensee performs communication. For example, in case of an allowable band 200, the permissible interference reference value associated with the received interference signal strength may be determined as to I_{A} and in case of a non-allowable band 210, the permissible interference reference value associated with the received interference signal strength may be determined as to I_{B}. In this case, I_{A} may be a smaller value than I_{B}. That is, the permissible interference reference value of the allowable band 200 can be set up lower than that of the non-allowable band 210.

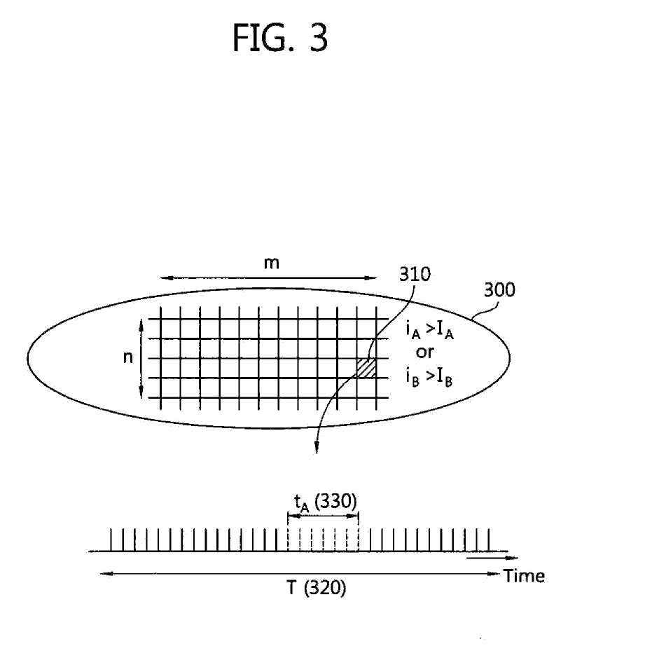

FIG. 3 illustrates an embodiment of the interference management based on received interference signal strength which the present invention is applied to.

Referring to FIG. 3, an interference region 310 can be detected, where the received interference signal strength i_{A} and i_{B} exceed permissible interference references I_{A} and I_{B} in comparison with a predetermined region 300, and the percentage q of the interference region 310 against the predetermined region 300 can be calculated. Herein, the i_{A} is referred to as received interference signal strength of an allowable band, i_{B} is referred to as received interference signal strength of a non-allowable band, I_{A} is referred to as a permissible interference reference of an allowable band, and I_{B} is referred to as a permissible interference reference of a non-allowable band. Additionally, the predetermined region 300 may be represented as the whole region for which a licensee gets permission, or represented as an arbitrary predetermined region. The predetermined region 300, for example, can be divided into m*n regions.

Also, an interference time t_{A} can be detected, when the received interference signal strength exceeds the permissible interference references within a predetermined time T 320 in the interference region 310, and the percentage r of the interference time t_{A} against the predetermined time T 320 can be calculated.

If the percentage q of the interference region and the percentage r of the interference time that are calculated based on the received interference signal within the permitted region do not exceed specific references, for example, Q and R, a licensee is supposed to permit it. That is, no objection is allowed. According to the method described above, a licensee considers the received interference signal which is going to receive in the real environment and is able to perform the interference management more accurately and reasonably in the radio interference management.

Most of all, in order to apply the method described above, the wireless communication systems must be enabled to make an accurate determination of the percentage q of the interference region and the percentage of the interference time r. For example, at a specific time of permitting a license, the percentage q of the interference region and the percentage of r of the interference time are calculated by using a radio signal calculation tool so as to determine whether to satisfy the specific references such as Q and R theoretically. However, in real environment, the radio signal has characteristics of changeable in real time. Therefore, the percentage q of the interference region and the percentage r of the interference time r can be calculated considering the characteristic of the radio signal above described, and determined whether the result satisfy specific references.

In mobile communication systems, the percentage q of the interference region and the percentage r of the interference time r can be calculated by using the result that a terminal measures the received interference signal strength. In the mobile communication systems, it may be assumed that terminals are evenly distributed within a predetermined region as user equipments move with mobility. Otherwise it may be assumed that more terminals are positioned in a certain location with weighting. Herein, the terminal is referred to as another terms such as a user equipment UE, a mobile station MS, a user terminal UT, a subscriber station ST, a wireless device, a personal digital assistant PDA, a wireless modem, a handheld device and so on.

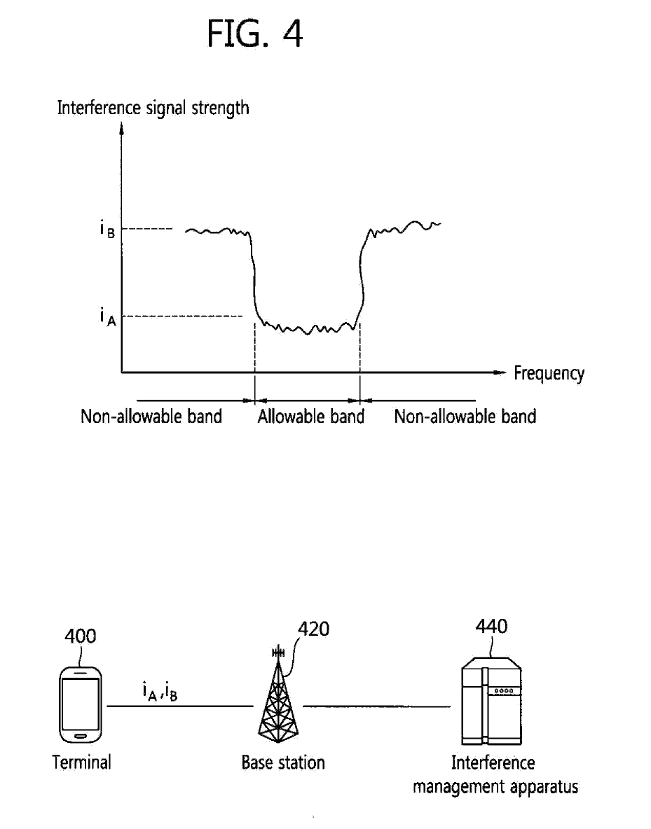

FIG. 4 illustrates an interference information measuring method according to an embodiment of the present invention. FIG. 4 depicts that an interference management apparatus is distinguished from a base station, but it is only for an example and the interference management apparatus may be included in a part of the base station.

Referring to FIG. 4, the terminals 400 which are located within a permitted region forward the interference information i_{A} and i_{B} which are obtained in an allowable band and non-allowable band respectively to the interference management apparatus 440 through the base station 420. The terminal 400 measures the interference strength i_{A} of the allowable band and the interference strength i_{B} of the non-allowable band respectively, and forwards the i_{A} and i_{B} to the base station 420 through a wireless link.

The base station 420 forwards the i_{A} and i_{B} of the terminals 400 within the region where the base station itself manages to the interference management apparatus 440. The base station 420, in this case, may forward the location information of the terminals 400 further more to the interference management apparatus 440.

The interference management apparatus 440 collects the information of the interference strength i_{A} of the allowable band and the interference strength i_{B} of the non-allowable band which are forwarded by multiple base stations 420 connected to wireless networks and by the terminal 400 connected to each of the base stations, and calculates the interference percentage based on the information above.

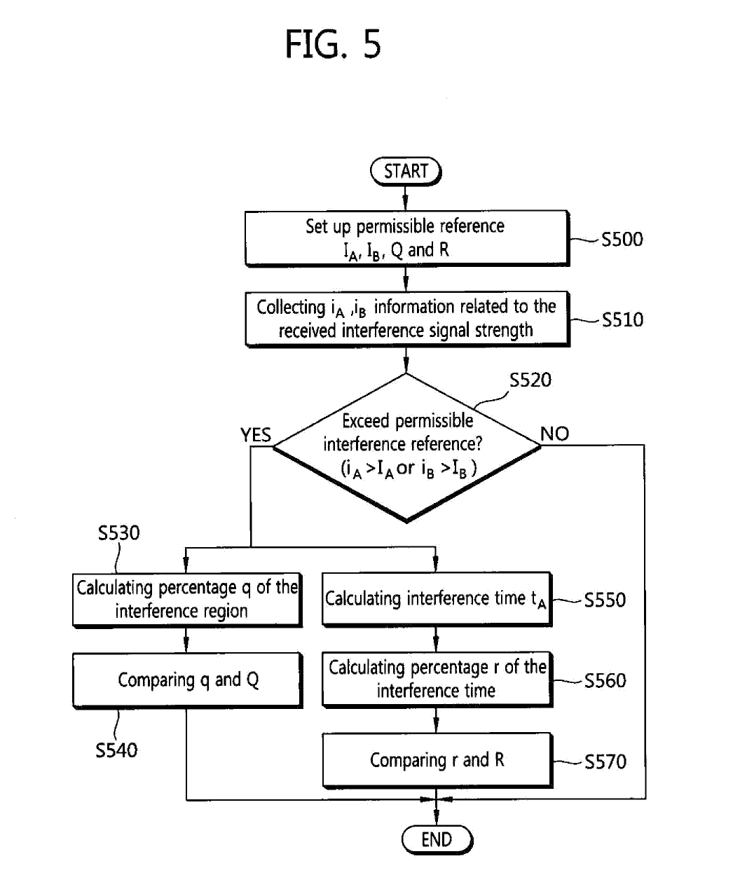

FIG. 5 illustrates an embodiment of the interference percentage calculating method based on the interference management apparatus according to the present invention.

Referring to FIG. 5, the interference management apparatus sets up a permissible interference reference I_{A} of an allowable band, a permissible interference reference I_{B} of a non-allowable band, a percentage reference Q of an interference region, and a percentage reference R of interference time (step, S500).

The interference management apparatus receives the information related to the received interference signal strength which is measured by terminals from at least one base station (step, S510). Herein, the information related to the received interference signal strength includes the received interference signal strength i_{A} of an allowable band and where the received interference signal strength i_{B} of a non-allowable band for each of the terminals. In addition, the information related to the received interference signal strength may further include the location information of the corresponding terminals.

The interference management apparatus determines whether to exceed the permissible interference reference (step, S520). The interference management apparatus may compare between I_{A}, I_{B}, i_{A} and i_{B}, and in case of i_{A}>I_{A} or i_{B}>I_{B}, may determine that the i_{A} and i_{B} exceed the permissible interference reference.

If the received interference signal strength exceeds the permissible interference reference in step, S520, the interference management apparatus calculates the percentage q of an interference region (step, S530). As an example, assuming that locations of the terminals are uniformly distributed, the interference management apparatus may directly calculate the percentage of the interference region based on the ratio of the number of terminals of which the received interference signal strength exceed the permissible interference reference against all terminals. As another example, the interference management apparatus may detect the location of terminals that exceed the permissible interference reference within a predetermined region (for example, a permitted region or service region) in further considering the location information of the terminals, and calculate the percentage of the interference region based on it.

The interference management apparatus compares the percentage q of the interference region calculated above and the percentage reference Q of an interference region which is set up beforehand, and determines whether the percentage q of the interference region exceeds the reference value Q (step, S540).

Further, if the received interference signal strength exceeds the permissible interference reference in step, S520, the interference management apparatus detects an interference time t_{A} (step, S550). The interference management apparatus may detect the interference time t_{A} when the received interference signal strength exceeds the permissible interference reference for a predetermined time T.

The interference management apparatus calculates the interference time percentage r based on the interference time t_{A} detected above (step, S550). For example, the interference management apparatus may detect t_{A} for the respective terminals which exceed the permissible interference reference, and based on this, calculate the percentage of the interference time for the respective terminals this and collect the result so as to calculate the percentage of the interference time. As another example, the interference management apparatus may detect the interference time t_{A} when the received interference signal strength exceeds the permissible interference reference for a predetermined time. T, and based on this, may calculate the percentage of the interference time for the respective interference regions.

The interference management apparatus compares the percentage r of the interference time calculated above and the percentage reference R of the interference time which is set up beforehand, and determines whether the percentage r of the interference time exceeds the reference value R (step, S570).

In the wireless communication system in which the radio signal is changeable in real time according to the method described above, it is available to calculate the percentage of the interference region and the percentage of the interference time, also to determine whether to exceed the reference value. On the basis of this, it is available to easily determine whether the received interference signal strength satisfies the interference reference which is represented as a percentage in wireless communication systems.

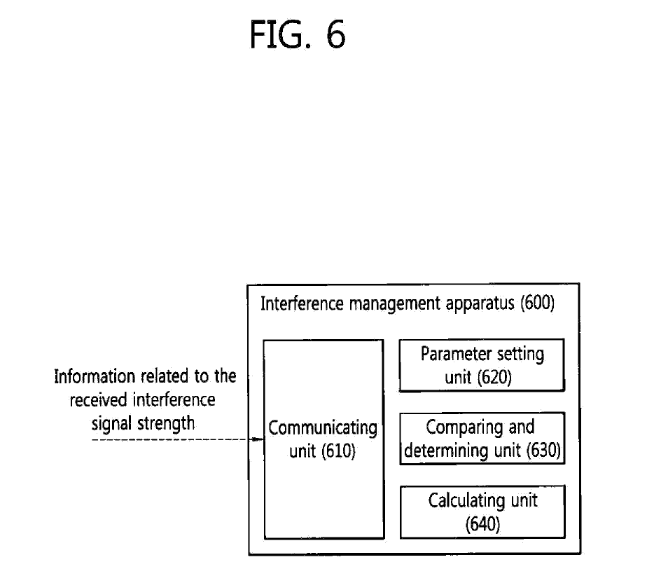

FIG. 6 is a block diagram schematically illustrating the interference management apparatus according to the present invention.

Referring to FIG. 6, the interference management apparatus 600 according to the present invention includes a communicating unit 610, parameter setting unit 620, a comparing and determining unit 630, and a calculating unit 640.

The communicating unit 610 performs communications with a terminal or base station. As an example, an interference management apparatus 600 may be constructed in a base station, and in this case, it is enabled to communicate directly with a terminal. As another example, in case of an interference management apparatus being constructed in a separate device, the interference management apparatus may directly communicate with a terminal without passing through any base station.

The communicating unit 610 receives the information of the received interference signal strength from at least a terminal or a base station. The received interference signal strength is measured by a terminal (terminals). The information of the received interference signal strength includes the received interference signal strength i_{A} of an allowable band and the received interference signal strength i_{B} of a non-allowable band for the respective terminals. Additionally, the information related to the received interference signal strength may further include the location information of the corresponding terminals.

The parameter setting unit 620 sets up the permissible interference reference I_{A} of an allowable band, permissible interference reference I_{B} of a non-allowable band, percentage reference Q of the interference region, and percentage reference R of the interference time.

The comparing and determining unit 630 determines whether to exceed the permissible interference reference based on the information related to the interference signal strength. The comparing and determining unit 630 compares between I_{A}, I_{B}, i_{A} and i_{B}, and may determine that the i_{A} and i_{B} exceed the permissible interference reference in case of i_{A}>I_{A} or i_{B}>I_{B}.

Additionally, based on the location information of the corresponding terminal, the comparing and determining unit 630 may determine the interference region where a terminal is located, which exceeds the permissible interference reference.

Furthermore, the comparing and determining unit 630 may detect the interference time t_{A} when the received interference signal strength exceeds the permissible reference within a predetermined time T.

The calculating unit 640 calculates the percentage q of the interference region. As an example, assuming that locations of the terminals are uniformly distributed, the calculating unit 640 may directly calculate the percentage of the interference region based on the ratio of the number of terminals of which the received interference signal strength exceed the permissible interference reference against all terminals. As another example, the calculating unit 640 may detect the location of terminals that exceed the permissible interference reference within a predetermined region (for example, a permitted region or service region) in further considering the location information of the terminals, and calculate the percentage of the interference region based on it.

In addition, the calculating unit 640 calculates the interference time percentage r based on the interference time t_{A} detected above. For example, the interference management apparatus may detect t_{A} for the respective terminals which exceed the permissible interference reference, and based on this, calculate the percentage of the interference time for the respective terminals this and collect the result so as to calculate the percentage of the interference time. As another example, the interference management apparatus may detect the interference time t_{A} when the received interference signal strength exceeds the permissible interference reference for a predetermined time T, and based on this, may calculate the percentage of the interference time for the respective interference regions.

The comparing and determining unit 630 may compare the percentage q of the interference region calculated above and the percentage reference Q of an interference region which is set up beforehand, and determine whether the percentage q of the interference region exceeds the reference value Q. The comparing and determining unit 630 may compare the percentage r of the interference time calculated above and the percentage reference R of the interference time which is set up beforehand, and determine whether the percentage r of the interference time exceeds the reference value R.

So far, the present invention has been described by reference to the drawings and the embodiments as an example, and it should be understood by those skilled in the art, however, that the present invention can be modified or changed, in various ways without departing from the technical principles and scope. Accordingly, the embodiment disclosed in the present invention is not intended to limit the scope of the inventive concept of the present invention, but to describe, and the scope of the inventive concept of the present invention is not limited to the embodiment. The scope of the present invention should be interpreted by the claims below, and it should be interpreted that all inventive concept within the equivalent scope is included in the scope of the present invention.

What is claimed is:

1. An interference management apparatus performing an interference management based on received interference signal strength, comprising:
a parameter setting unit configured to set up a permissible interference reference I_{A} of an allowable band and a percentage reference Q of an interference region;
a communicating unit configured to receive information related to the received interference signal strength which is measured by at least a terminal from at least a terminal or a base station; and
a comparing and determining unit configured to determine that interference excess is generated, if the received interference signal strength i_{A} of an allowable band exceeds the permissible interference reference I_{A}.

2. The interference management apparatus of claim 1, further comprising a calculating unit configured to calculate a percentage q of the interference region representing a ratio of a region where an interference occurs against a predetermined region based on the information of whether the interference excess is generated for the respective terminals.

3. The interference management apparatus of claim 2,
wherein the comparing and determining unit detects interference time t_{A} when the interference excess is generated within a predetermined time T, and
wherein the calculating unit calculates an interference time percentage r based on the interference time t_{A} detected above.

4. The interference management apparatus of claim 3, wherein the comparing and determining unit compares the percentage q of the interference region and the percentage reference Q of the interference region, and determines whether the percentage q of the interference region exceeds the reference value Q based on the information of the received interference signal strength.

5. The interference management apparatus of claim 4,
wherein the parameter setting unit further sets up a percentage reference R of the interference time, and
wherein the comparing and determining unit compares the percentage r of the interference time and the percentage reference R of the interference time, and determines whether the percentage r of the interference time exceeds the reference value R.

6. The interference management apparatus of claim 5,
wherein the communicating unit receives the information related to the received interference signal strength including the location information of respective terminals,
wherein the comparing and determining unit detects the interference region based on the location information of respective terminals, and
wherein the calculating unit calculates the percentage q of the interference region based on the detected interference region.

7. The interference management apparatus of claim 6, wherein the calculating unit detects the interference time t_{A} for the respective interference regions based on the information related to the interference region, and calculates the percentage q of the interference time for the respective interference regions.

8. The interference management apparatus of claim 5,
wherein the parameter setting unit further sets up a permissible interference reference I_{B} of a non-allowable band, and
wherein the comparing and determining unit determines that interference excess is generated, if the received interference signal strength i_{B} of the non-allowable band for the respective terminals exceeds the permissible interference reference I_{B} based on the information related to the received interference signal strength.

9. A method for managing interference performed based on received interference signal strength, comprising:
setting up a permissible interference reference I_{A} of an allowable band and a percentage reference Q of an interference region;
receiving information related to the received interference signal strength which is measured by at least a terminal from at least a terminal or a base station; and
determining that interference excess is generated, if the received interference signal strength i_{A} of an allowable band for respective terminals exceeds the permissible interference reference I_{A}.

10. The method for managing interference of claim 9, further comprising calculating a percentage q of the interference region representing a ratio of a region where an interference occurs against a predetermined region based on the information of whether the interference excess is generated for the respective terminals.

11. The method for managing interference of claim 10, further comprising:
detecting interference time t_{A} when the interference excess is generated within a predetermined time T, and
calculating an interference time percentage r based on the interference time t_{A} detected above.

12. The method for managing interference of claim 11, further comprising:
comparing the percentage q of the interference region and the percentage reference Q of the interference region, and
determining whether the percentage q of the interference region exceeds the reference value Q.

13. The method for managing interference of claim 12, further comprising:
setting up a percentage reference R of the interference time, and
comparing the percentage r of the interference time and the percentage reference R of the interference time, and determines whether the percentage r of the interference time exceeds the reference value R.

14. The method for managing interference of claim 13, further comprising detecting the interference region based on the information related to the received interference signal strength,
wherein the information related to the received interference signal strength includes the location information of respective terminals, and the interference region is detected based on the location information, and
wherein the percentage q of the interference region is calculated based on the detected interference region.

15. The method for managing interference of claim 14,
wherein the interference time t_{A} is detected for the respective terminals, and
wherein the percentage q of the interference time is calculated for the respective interference regions.

16. The method for managing interference of claim 12, further comprising setting up a permissible interference reference I_{B} of a non-allowable band,
wherein it is also determined that the interference excess is generated, if a received interference signal strength i_{B} of a non-allowable band for the respective terminals, which is obtained based on the information related to the received interference signal strength, exceeds the permissible interference reference I_{B}.

17. An interference management systems based on received interference signal strength, comprising:
at least a terminal configured to measure at least one of the received interference signal strength i_{A} of an allowable band and the received interference signal strength i_{B} of a non-allowable band;
at least a base station configured to receive at least one of the i_{A} and i_{B} from at least one of the terminals; and
an interference management apparatus configured to receive at least one of the i_{A} and i_{B} from at least one of the base stations, and to compare the i_{A} or i_{B} with the permissible interference reference I_{A} of the allowable band or the permissible interference reference I_{B} of the non-allowable band, and to determine whether interference excess is generated for each terminal.

18. The interference management system of claim 17, wherein the interference management apparatus calculates a percentage q of the interference region representing a ratio of a region where an interference occurs against a predetermined region based on the information of whether the interference excess is generated for the respective terminals, detects interference time t_{A} when the interference excess is generated within a predetermined time T, and calculates an interference time percentage r based on the interference time t_{A} detected above.

19. The interference management system of claim 18, wherein the interference management apparatus determines whether the percentage q of the interference region exceeds the reference value Q, and determines whether the percentage r of the interference time exceeds the reference value R.

20. The interference management system of claim 19, wherein the interference management apparatus further receives location information of at least one terminal above from at least one base station, detects an interference region where an interference excess is generated based on the location information, and calculates a percentage q of the interference region based on the interference region.
